(19) United States
(12) Patent Application Publication
(10) Pub. No.: US 2026/0257499 A1
(43) Pub. Date: Sep. 3, 2026

(54) PRINTING APPARATUS

(71) Applicant: BROTHER KOGYO KABUSHIKI KAISHA, Nagoya (JP)

(72) Inventor: Yoshiya TOMATSU, Kasugai (JP)

(21) Appl. No.: 19/547,921

(22) Filed: Feb. 24, 2026

(30) Foreign Application Priority Data
Feb. 28, 2025 (JP) 2025-032230

(51) Int. Cl. B41J 11/14; B41J 11/06

(52) U.S. Cl. CPC B41J 11/14; B41J 11/06

(57) ABSTRACT

A printing apparatus includes: a rail extending in a conveying direction of a printed medium; a platen support member mounted on the rail, and configured to: support a platen on which the printed medium is placed; and move the platen along the rail between a printing position where liquid droplets are ejected from an ejection head to the printed medium and a set position where the printed medium is set on the platen; a first rail fixing member provided between one end and the other end of the rail in the conveying direction, and configured to fix the rail; and a second rail fixing member provided at a position between the one end and the other end of the rail in the conveying direction and away from the first rail fixing member, and configured to fix the rail.

### REFERENCE TO RELATED APPLICATIONS

This application claims priority from Japanese Patent Application No. 2025-032230 filed on February 28, 2025. The entire contents of the priority application are incorporated herein by reference.

### BACKGROUND ART

In a related art, a printing apparatus is known in which a platen on which a printed medium is placed is conveyed along a conveying guide between a set position where the printed medium is set on the platen and a printing position where ink droplets are ejected from an ejection head.

### SUMMARY

The platen is mounted on a rail extending in a conveying direction and conveyed. It is conceivable that the rail has a front end which is one end in the conveying direction and a trailing end which is the other end, and the front end and the trailing end are fixed to a housing of the printing apparatus.

However, when the rail is bent due to the weight of the platen, an external force, or the like, the platen may deviate from a desired position. When the platen deviates from a desired position, landing positions of the ink droplets ejected from the ejection head deviate, and the landing accuracy decreases. Therefore, there is a possibility that the image quality deteriorates.

The present disclosure aims to provide a printing apparatus capable of preventing deterioration in image quality.

A printing apparatus according to the present disclosure includes: a rail extending in a conveying direction of a printed medium; a platen support member mounted on the rail, the platen support member configured to: support a platen on which the printed medium is placed; and move the platen along the rail between a printing position where liquid droplets are ejected from an ejection head to the printed medium and a set position where the printed medium is set on the platen; a first rail fixing member provided between one end and the other end of the rail in the conveying direction, the first rail fixing member configured to fix the rail; and a second rail fixing member provided at a position between the one end and the other end of the rail in the conveying direction and away from the first rail fixing member, the second rail fixing member configured to fix the rail.

According to the present disclosure, the first rail fixing member and the second rail fixing member fix the rail at a position closer to the printing position than one end and the other end of the rail in the conveying direction. Therefore, compared with a case in which the one end and the other end of the rail in the conveying direction are fixed, the rail is less likely to bend due to the weight of the platen, an external force, or the like. Therefore, the amount of deviation of the platen from the desired position is reduced. Accordingly, it is possible to prevent a decrease in landing accuracy due to a deviation of landing positions of liquid droplets ejected from the ejection head. Therefore, deterioration in image quality can be prevented.

### BRIEF DESCRIPTION OF DRAWINGS

FIG. 1 is a perspective view illustrating a printing apparatus according to an embodiment.

FIG. 2 is a perspective view illustrating the printing apparatus as viewed from a direction different from that in FIG. 1.

FIG. 3 is a perspective view illustrating the printing apparatus as viewed from a direction different from those in FIGS. 1 and 2.

FIG. 4 is a perspective view illustrating a configuration in which a part of a guide frame in the printing apparatus illustrated in FIG. 1 is removed.

FIG. 5 is a perspective view illustrating a configuration in which the part of the guide frame in the printing apparatus is removed as viewed from a direction different from that in FIG. 4.

FIG. 6 is a perspective view illustrating a drive mechanism for operating a drive belt.

FIG. 7 is a diagram illustrating a height position of fixation implemented by a first central rail fixing member, a height position of fixation implemented by a first left rail fixing member, and a height position of fixation implemented by a first right rail fixing member.

FIG. 8 is a diagram illustrating a height position of fixation implemented by a second central rail fixing member, a height position of fixation implemented by a second left rail fixing member, and a height position of fixation implemented by a second right rail fixing member.

FIG. 9 is a perspective view illustrating a configuration of a lower portion of a platen support member.

FIG. 10 is a perspective view illustrating a configuration for fixing the drive belt to the platen support member.

FIG. 11 is a schematic plan view illustrating a fixing position of the drive belt with respect to the platen support member.

### DESCRIPTION

Hereinafter, an embodiment of the present disclosure will be described with reference to the drawings. The embodiment described below is merely one embodiment of the present disclosure. Accordingly, the present disclosure is not limited to the following embodiment, and the embodiment can be added, deleted, or modified without departing from the scope of the present disclosure. In the following description, the same or corresponding elements in all the drawings are denoted by the same reference signs, and redundant description thereof is omitted unless otherwise noted.

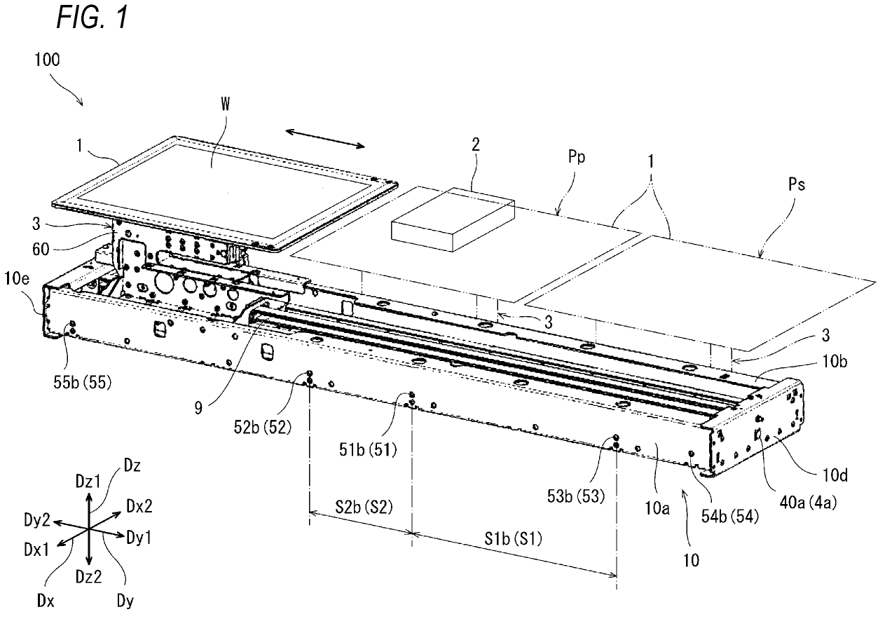

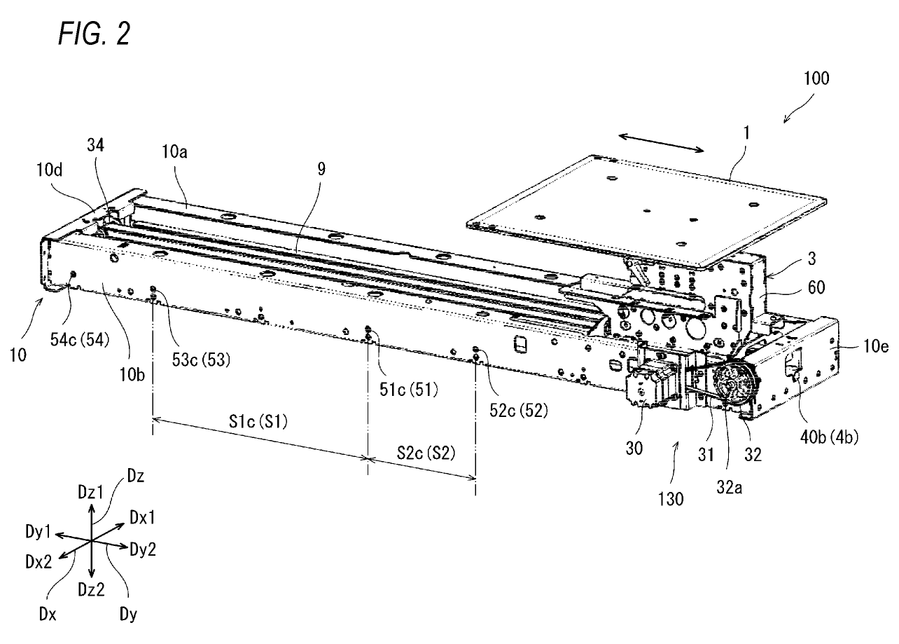

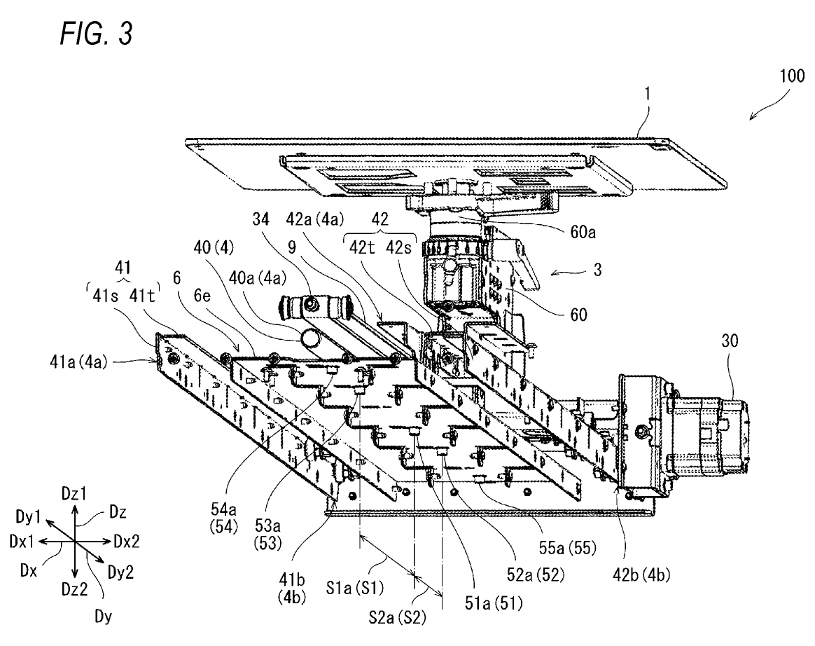

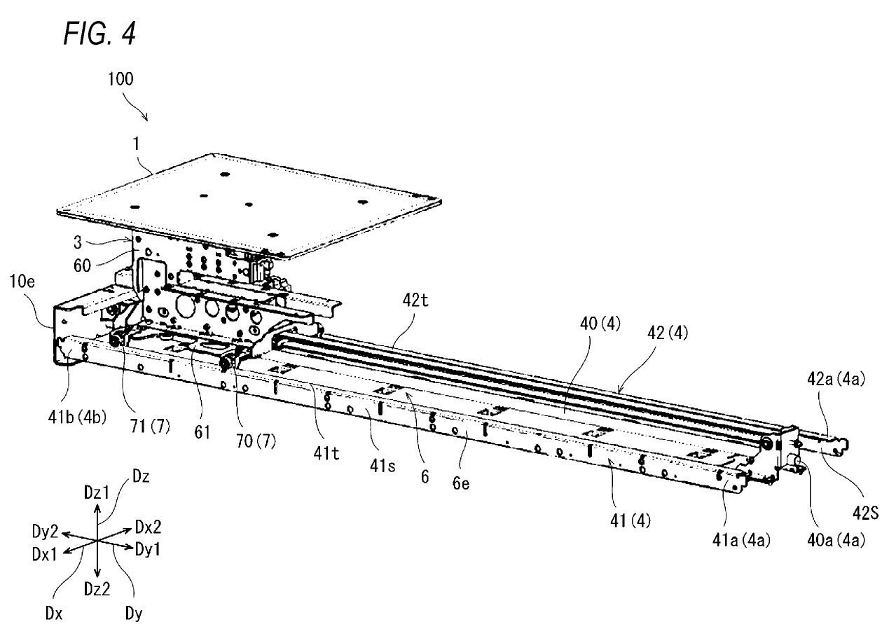

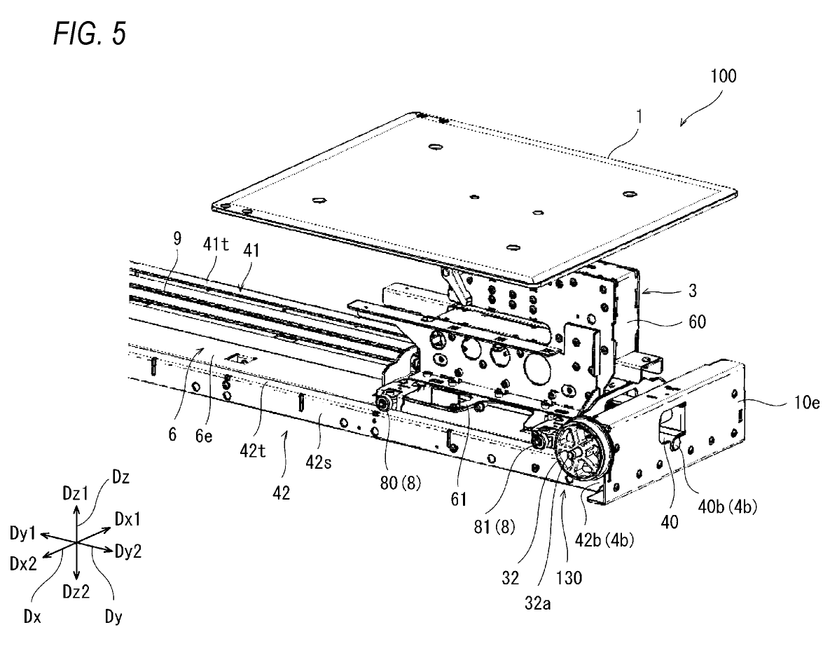

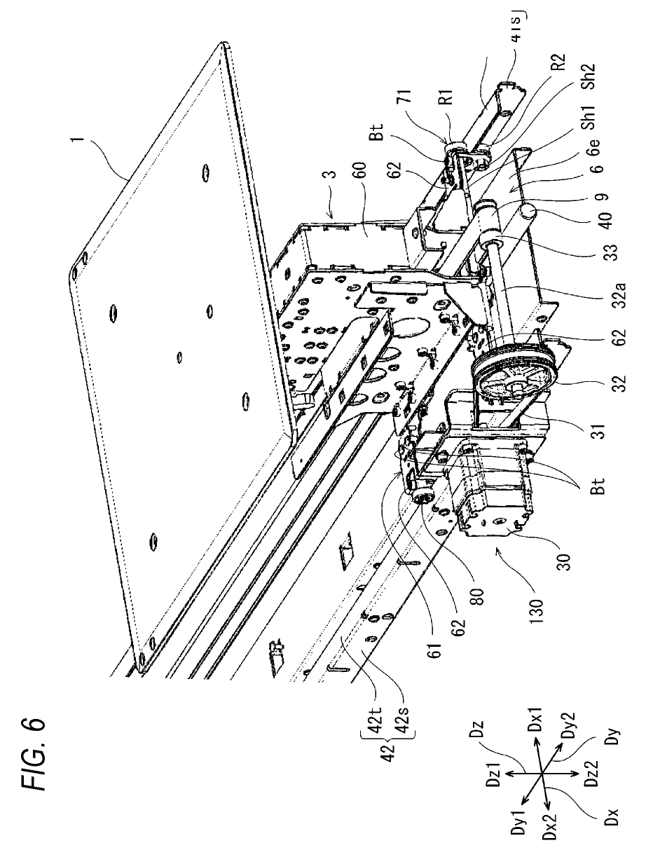

FIG. 1 is a perspective view illustrating a printing apparatus 100 according to an embodiment. FIG. 2 is a perspective view illustrating the printing apparatus 100 as viewed from a direction different from that in FIG. 1. FIG. 3 is a perspective view illustrating the printing apparatus 100 as viewed from a direction different from those in FIGS. 1 and 2. FIG. 4 is a perspective view illustrating a configuration in which a part of a guide frame 10 in the printing apparatus 100 illustrated in FIG. 1 is removed. FIG. 5 is a perspective view illustrating a configuration in which the part of the guide frame 10 in the printing apparatus 100 is removed as viewed from a direction different from that in FIG. 4. FIG. 6 is a perspective view illustrating a drive mechanism 130 for operating a drive belt.

In FIGS. 1 to 6 and each of the drawings to be described later, directions orthogonal to one another are referred to as a first direction Dy, a second direction Dx and a third direction Dz. In the present embodiment, for example, the first direction Dy is a conveying direction of a printed medium W, the second direction Dx is a movement direction of a carriage (not illustrated) that supports an ejection head 2, and the third direction Dz is an up-down direction. In the following description, Dx is referred to as a left-right direction, Dy is referred to as the conveying direction, and Dz is referred to as the up-down direction. One direction of the conveying direction Dy is referred to as a forward direction Dy1, and the other direction is referred to as a backward direction Dy2. The printed medium W is conveyed, for example, in the forward direction Dy1 during printing. One direction of the left-right direction Dx is referred to as a left direction Dx1, and the other direction is referred to as a right direction Dx2. One direction of the up-down direction Dz is referred to as an upward direction Dz1, and the other direction is referred to as a downward direction Dz2. However, the above directions are examples and are not limited.

As illustrated in FIGS. 1 to 3, the printing apparatus 100 includes a platen 1, an ejection head 2, a platen support member 3, a guide frame 10, a first rail fixing member 51, a second rail fixing member 52, a third rail fixing member 53, a fourth rail fixing member 54, a fifth rail fixing member 55, and a drive mechanism 130. Further, the printing apparatus 100 includes a rail 4 and a central plate 6 illustrated in FIG. 4 described later.

The platen 1 is formed in, for example, a plate shape. The printed medium W is placed on the platen 1. Accordingly, the platen 1 supports the printed medium W. The platen 1 moves in the conveying direction Dy. The ejection head 2 is, for example, a serial head type inkjet head. The printing apparatus 100 alternately repeats pass processing in which the ejection head 2 is moved in the left-right direction Dx based on the printing data while ejecting ink droplets from the ejection head 2 onto the printed medium W, and conveying processing in which the printed medium W is conveyed in the conveying direction Dy. Accordingly, a prescribed image is printed on the printed medium W.

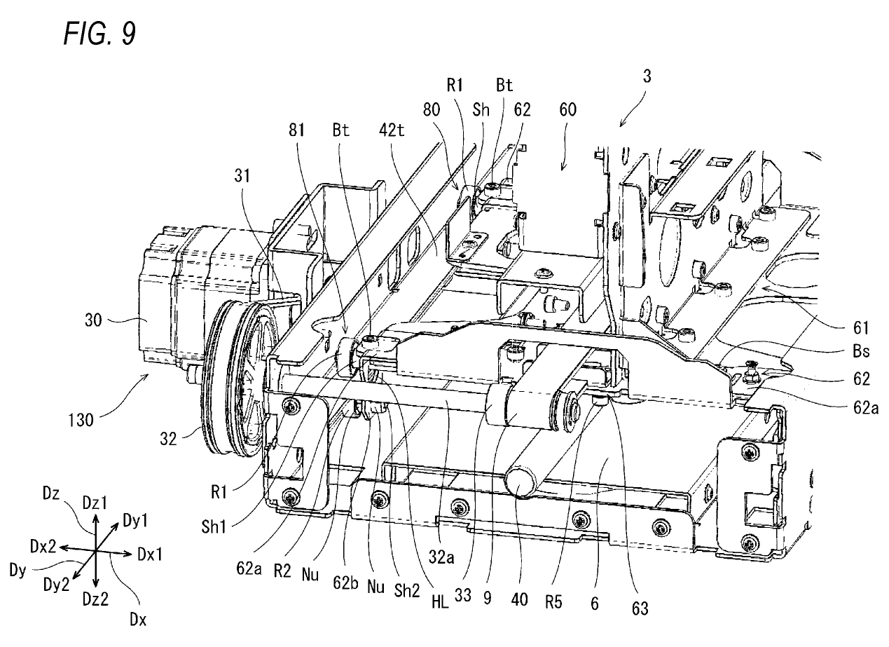

As illustrated in FIGS. 4 and 5, the platen support member 3 includes a left roller pair 7 and a right roller pair 8. The left roller pair 7 includes a first left roller pair 70 and a second left roller pair 71. The right roller pair 8 includes a first right roller pair 80 and a second right roller pair 81. The platen support member 3 includes a support column portion 60 illustrated in FIG. 1 and a base plate 61 illustrated in FIG. 9 described later. Further, the platen support member 3 includes a roller attachment member 62 illustrated in FIG. 9 described later, which is provided corresponding to each of the first left roller pair 70, the first right roller pair 80, the second left roller pair 71, and the second right roller pair 81.

The support column portion 60 is formed in, for example, a U shape that opens forward. A support portion 60a illustrated in FIG. 3 extending in the up-down direction Dz is provided at a front end of an upper portion of the support column portion 60. The support portion 60a supports the platen 1 from below. The support column portion 60 is provided at the center of the base plate 61 in the left-right direction Dx. The base plate 61 supports a lower end of the support column portion 60 from below. The first left roller pair 70, the first right roller pair 80, the second left roller pair 71, the second right roller pair 81, and the roller attachment member 62 of the platen support member 3 will be described in detail later.

The platen support member 3 moves the platen 1 in the conveying direction Dy by the drive mechanism 130. In this case, the first left roller pair 70 and the second left roller pair 71 of the platen support member 3 move in the conveying direction Dy along a left rail 41 described later, and the first right roller pair 80 and the second right roller pair 81 move in the conveying direction Dy along a right rail 42 described later, whereby the platen 1 is conveyed in the conveying direction Dy. Specifically, the platen support member 3 moves the platen 1 along the rail 4 described later between a printing position Pp and a set position Ps illustrated in FIG. 1. The printing position Pp is a position where ink droplets are ejected from the ejection head 2 onto the printed medium W placed on the platen 1. The set position Ps is a position where the printed medium W is set on the platen 1.

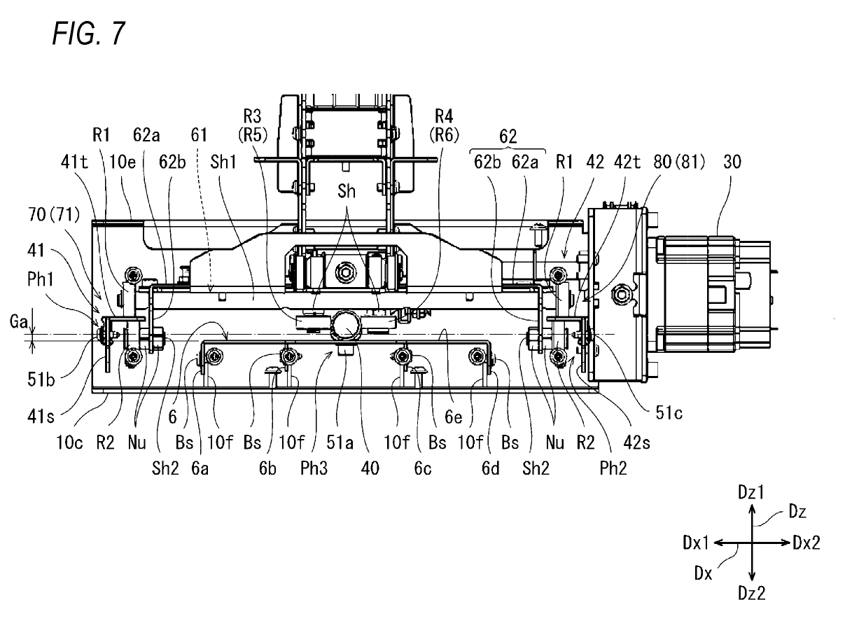

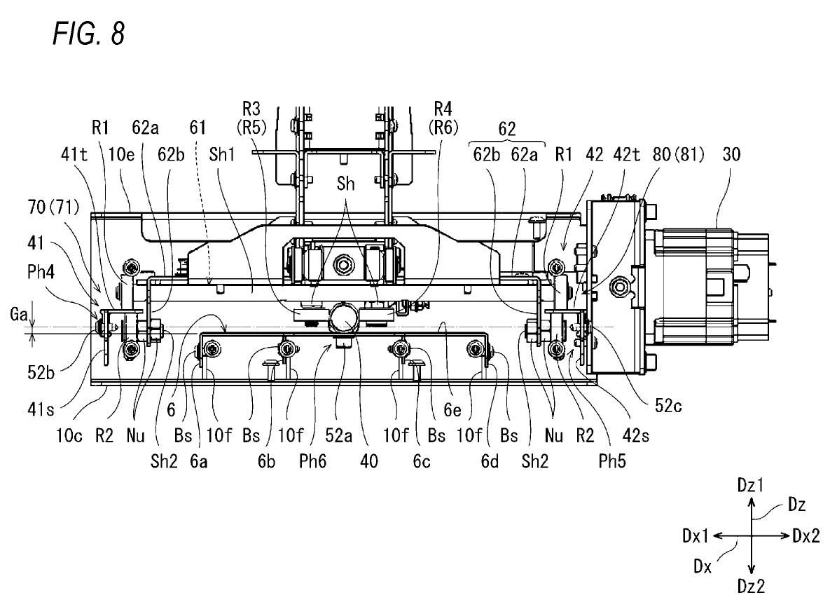

The central plate 6 illustrated in FIG. 4 extends in the conveying direction Dy and the left-right direction Dx. The central plate 6 is provided below a central rail 40 illustrated in FIG. 4. The central plate 6 is provided above a bottom frame 10c in FIGS. 7 and 8 described later. Details of the central plate 6 will be described later.

The guide frame 10 is a box that opens upward. The guide frame 10 includes a left frame 10a, a right frame 10b, a front frame 10d, and a rear frame 10e illustrated in FIG. 1. Further, the guide frame 10 has a bottom frame 10c illustrated in FIG. 7 described later.

The left frame 10a extends in the conveying direction Dy and is disposed on a left side of the platen support member 3. The right frame 10b extends in the conveying direction Dy in parallel with the left frame 10a and is disposed on a right side of the platen support member 3. The front frame 10d is connected to a front end of the left frame 10a and a front end of the right frame 10b and extends in the left-right direction Dx. The rear frame 10e is connected to a trailing end of the left frame 10a and a trailing end of the right frame 10b and extends in the left-right direction Dx.

As illustrated in FIGS. 3 to 5, the rail 4 includes the central rail 40, the left rail 41, and the right rail 42.

The central rail 40 is, for example, a round bar and extends in the conveying direction Dy. The central rail 40 is disposed between the left rail 41 and the right rail 42 in the left-right direction Dx, and in this case, for example, an interval between the central rail 40 and the left rail 41 in the left-right direction Dx is the same as an interval between the central rail 40 and the right rail 42 in the left-right direction Dx. As illustrated in FIG. 3, the central rail 40 is disposed on an upper portion 6e of the central plate 6.

The left rail 41 has, for example, an L-shaped cross section and extends in the conveying direction Dy. The left rail 41 is provided on the left side with respect to the central rail 40. The left rail 41 includes a side member 41s and an upper member 41t. The side member 41s extends in the up-down direction Dz. The upper member 41t is coupled to an upper end of the side member 41s and extends in the right direction Dx2. The side member 41s of the left rail 41 is disposed on the right side of the left frame 10a.

The right rail 42 has, for example, an L-shaped cross section and extends in the conveying direction Dy. The right rail 42 is provided on the right side with respect to the central rail 40. The right rail 42 includes a side member 42s and an upper member 42t. The side member 42s extends in the up-down direction Dz. The upper member 42t is coupled to an upper end of the side member 42s and extends in the left direction Dx1. The side member 42s of the right rail 42 is disposed on the left side of the right frame 10b.

As illustrated in FIG. 2, the drive mechanism 130 includes an electric motor 30, a drive belt 31, a pulley 32, a shaft 32a, a drive belt 9, and a pulley 34. Further, the drive mechanism 130 includes a pulley 33 illustrated in FIG. 6.

A pulley (not illustrated) is provided on a rotation shaft of the electric motor 30, and the drive belt 31 is wound around the pulley and the pulley 32. The pulley 32 is connected to a right end of the shaft 32a, and the pulley 33 is connected to a left end of the shaft 32a. The drive belt 9 extends in the conveying direction Dy and moves the platen support member 3 in the conveying direction Dy. The drive belt 9 is wound around the pulley 33 and the pulley 34. A part of the drive belt 9 is fixed to the platen support member 3. The configuration for fixing the drive belt 9 to the platen support member 3 will be described in detail later.

A driving force of the electric motor 30 is transmitted to a pulley 32 via a pulley (not illustrated) provided on the rotation shaft of the electric motor 30 and the drive belt 31. The driving force transmitted to the pulley 32 is transmitted to the pulley 33 via the shaft 32a. Accordingly, the pulley 33 rotates, and the drive belt 9 moves by rotating the pulley 34 according to a rotational force of the pulley 33. When the drive belt 9 moves in this manner, the platen support member 3 to which a part of the drive belt 9 is fixed as described above moves in the conveying direction Dy. Accordingly, the platen 1 on which the printed medium W is placed moves in the conveying direction Dy.

Next, the first rail fixing member 51, the second rail fixing member 52, the third rail fixing member 53, the fourth rail fixing member 54, and the fifth rail fixing member 55 will be described.

### First Rail Fixing Member

The first rail fixing member 51 fixes the rail 4. As illustrated in FIGS. 1 to 3, the first rail fixing member 51 is provided between a front end 4a which is an example of one end of the rail 4 and a trailing end 4b which is an example of the other end in the conveying direction Dy. The first rail fixing member 51 is provided, in the conveying direction Dy, between the third rail fixing member 53 described later provided in front of the first rail fixing member 51 in the conveying direction Dy and the second rail fixing member 52 described later provided behind the first rail fixing member 51 in the conveying direction Dy. The first rail fixing member 51 is provided closer to the front end than the platen support member 3 in the conveying direction Dy in a state in which the platen support member 3 is disposed at the printing position Pp.

The first rail fixing member 51 is, for example, a screw. As illustrated in FIGS. 1 to 3, the first rail fixing member 51 includes a first central rail fixing member 51a, a first left rail fixing member 51b, and a first right rail fixing member 51c. The first central rail fixing member 51a, the first left rail fixing member 51b, and the first right rail fixing member 51c are provided at the same position in the conveying direction Dy.

The first central rail fixing member 51a fixes the central rail 40 illustrated in FIG. 4 in the left-right direction Dx. In this case, the first central rail fixing member 51a is fastened to the central plate 6 and the central rail 40 illustrated in FIG. 4 in the up-down direction Dz. That is, the first central rail fixing member 51a is screwed in the up-down direction Dz. Accordingly, the central rail 40 is fixed to the central plate 6 in the left-right direction Dx.

The first left rail fixing member 51b fixes the left rail 41 illustrated in FIG. 4 in the up-down direction Dz. In this case, the first left rail fixing member 51b is fastened to the left frame 10a illustrated in FIG. 1 and the side member 41s of the left rail 41 in the left-right direction Dx. That is, the first left rail fixing member 51b is screwed in the left-right direction Dx. Accordingly, the left rail 41 is fixed to the left frame 10a in the up-down direction Dz.

The first right rail fixing member 51c fixes the right rail 42 illustrated in FIG. 4 in the up-down direction Dz. In this case, the first right rail fixing member 51c is fastened to the right frame 10b illustrated in FIG. 2 and the side member 42s of the right rail 42 in the left-right direction Dx. That is, the first right rail fixing member 51c is screwed in the left-right direction Dx. Accordingly, the right rail 42 is fixed to the right frame 10b in the up-down direction Dz.

### Second Rail Fixing Member

The second rail fixing member 52 fixes the rail 4. As illustrated in FIGS. 1 to 3, the second rail fixing member 52 is provided at a position between the front end 4a and the trailing end 4b of the rail 4 in the conveying direction Dy and away from the first rail fixing member 51. The second rail fixing member 52 is provided behind the first rail fixing member 51 in the conveying direction Dy. The second rail fixing member 52 is provided closer to the trailing end than the platen support member 3 in the conveying direction Dy in a state in which the platen support member 3 is disposed at the printing position Pp.

The second rail fixing member 52 is, for example, a screw similarly to the first rail fixing member 51. The third rail fixing member 53, the fourth rail fixing member 54, and the fifth rail fixing member 55 described later are also screws, for example. As illustrated in FIGS. 1 to 3, the second rail fixing member 52 includes a second central rail fixing member 52a, a second left rail fixing member 52b, and a second right rail fixing member 52c. The second central rail fixing member 52a, the second left rail fixing member 52b, and the second right rail fixing member 52c are provided at the same position in the conveying direction Dy.

The second central rail fixing member 52a fixes the central rail 40 illustrated in FIG. 4 in the left-right direction Dx. In this case, the second central rail fixing member 52a is fastened to the central plate 6 and the central rail 40 illustrated in FIG. 4 in the up-down direction Dz. The second left rail fixing member 52b fixes the left rail 41 illustrated in FIG. 4 in the up-down direction Dz. In this case, the second left rail fixing member 52b is fastened to the left frame 10a illustrated in FIG. 1 and the side member 41s of the left rail 41 in the left-right direction Dx. The second right rail fixing member 52c fixes the right rail 42 illustrated in FIG. 4 in the up-down direction Dz. In this case, the second right rail fixing member 52c is fastened to the right frame 10b illustrated in FIG. 2 and the side member 42s of the right rail 42 in the left-right direction Dx.

### Third Rail Fixing Member

The third rail fixing member 53 fixes the rail 4. As illustrated in FIGS. 1 to 3, the third rail fixing member 53 is provided at a position between the front end 4a and the trailing end 4b of the rail 4 in the conveying direction Dy and away from the first rail fixing member 51 and the second rail fixing member 52. The third rail fixing member 53 is provided in front of the first rail fixing member 51 and the second rail fixing member 52 in the conveying direction Dy.

As illustrated in FIGS. 1 to 3, the third rail fixing member 53 includes a third central rail fixing member 53a, a third left rail fixing member 53b, and a third right rail fixing member 53c. The third central rail fixing member 53a, the third left rail fixing member 53b, and the third right rail fixing member 53c are provided at the same position in the conveying direction Dy.

The third central rail fixing member 53a fixes the central rail 40 illustrated in FIG. 4 in the left-right direction Dx. In this case, the third central rail fixing member 53a is fastened to the central plate 6 and the central rail 40 illustrated in FIG. 4 in the up-down direction Dz. The third left rail fixing member 53b fixes the left rail 41 illustrated in FIG. 4 in the up-down direction Dz. In this case, the third left rail fixing member 53b is fastened to the left frame 10a illustrated in FIG. 1 and the side member 41s of the left rail 41 in the left-right direction Dx. The third right rail fixing member 53c fixes the right rail 42 illustrated in FIG. 4 in the up-down direction Dz. In this case, the third right rail fixing member 53c is fastened to the right frame 10b illustrated in FIG. 2 and the side member 42s of the right rail 42 in the left-right direction Dx.

### Other Rail Fixing Members

The fourth rail fixing member 54 fixes the rail 4. As illustrated in FIGS. 1 to 3, the fourth rail fixing member 54 is provided in front of the third rail fixing member 53 in the conveying direction Dy. As illustrated in FIGS. 1 to 3, the fourth rail fixing member 54 includes a fourth central rail fixing member 54a, a fourth left rail fixing member 54b, and a fourth right rail fixing member 54c. The fourth left rail fixing member 54b and the fourth right rail fixing member 54c are provided at the same position in the conveying direction Dy. The fourth central rail fixing member 54a is provided behind the fourth left rail fixing member 54b and the fourth right rail fixing member 54c in the conveying direction Dy. The fourth central rail fixing member 54a fixes the central rail 40 illustrated in FIG. 4 in the left-right direction Dx, similarly to the first central rail fixing member 51a, the second central rail fixing member 52a, and the third central rail fixing member 53a. The fourth left rail fixing member 54b fixes the left rail 41 illustrated in FIG. 4 in the up-down direction Dz, similarly to the first left rail fixing member 51b, the second left rail fixing member 52b, and the third left rail fixing member 53b. The fourth right rail fixing member 54c fixes the right rail 42 illustrated in FIG. 4 in the up-down direction Dz, similarly to the first right rail fixing member 51c, the second right rail fixing member 52c, and the third right rail fixing member 53c.

The fifth rail fixing member 55 fixes the rail 4. As illustrated in FIGS. 1 to 3, the fifth rail fixing member 55 is provided behind the second rail fixing member 52 in the conveying direction Dy. As illustrated in FIGS. 1 to 3, the fifth rail fixing member 55 includes a fifth central rail fixing member 55a, a fifth left rail fixing member 55b, and a fifth right rail fixing member 55c. The fifth left rail fixing member 55b and the fifth right rail fixing member 55c are provided at the same position in the conveying direction Dy. The fifth central rail fixing member 55a is provided in front of the fifth left rail fixing member 55b and the fifth right rail fixing member 55c in the conveying direction Dy. The fifth central rail fixing member 55a fixes the central rail 40 illustrated in FIG. 4 in the left-right direction Dx, similarly to the first central rail fixing member 51a, the second central rail fixing member 52a, the third central rail fixing member 53a, and the fourth central rail fixing member 54a. The fifth left rail fixing member 55b fixes the left rail 41 illustrated in FIG. 4 in the up-down direction Dz, similarly to the first left rail fixing member 51b, the second left rail fixing member 52b, the third left rail fixing member 53b, and the fourth left rail fixing member 54b. The fifth right rail fixing member 55c fixes the right rail 42 illustrated in FIG. 4 in the up-down direction Dz, similarly to the first right rail fixing member 51c, the second right rail fixing member 52c, the third right rail fixing member 53c, and the fourth right rail fixing member 54c.

### Interval Between Rail Fixing Members

As illustrated in FIGS. 1 to 3, a first interval S1 between the third rail fixing member 53 and the first rail fixing member 51 in the conveying direction Dy is larger than a second interval S2 between the first rail fixing member 51 and the second rail fixing member 52 in the conveying direction Dy.

Specifically, a first interval S1a between the third central rail fixing member 53a and the first central rail fixing member 51a in the conveying direction Dy is larger than a second interval S2a between the first central rail fixing member 51a and the second central rail fixing member 52a in the conveying direction Dy. A first interval S1b between the third left rail fixing member 53b and the first left rail fixing member 51b in the conveying direction Dy is larger than a second interval S2b between the first left rail fixing member 51b and the second left rail fixing member 52b in the conveying direction Dy. A first interval S1c between the third right rail fixing member 53c and the first right rail fixing member 51c in the conveying direction Dy is larger than a second interval S2c between the first right rail fixing member 51c and the second right rail fixing member 52c in the conveying direction Dy. Each of the intervals is, for example, an interval in the conveying direction Dy between the axial center of one rail fixing member and the axial center of the other rail fixing member.

### Height Position of Fixation Implemented by Rail Fixing Member

FIG. 7 is a diagram illustrating a height position of fixation implemented by the first central rail fixing member 51a, a height position of fixation implemented by the first left rail fixing member 51b, and a height position of fixation implemented by the first right rail fixing member 51c. FIG. 8 is a diagram illustrating a height position of fixation implemented by the second central rail fixing member 52a, a height position of fixation implemented by the second left rail fixing member 52b, and a height position of fixation implemented by the second right rail fixing member 52c. In FIGS. 7 and 8, illustration of the left frame 10a, the right frame 10b, and the front frame 10d is omitted for convenience of description.

As illustrated in FIG. 7, a height position Ph1 at which the first left rail fixing member 51b fixes the left rail 41 and a height position Ph2 at which the first right rail fixing member 51c fixes the right rail 42 are higher than a height position Ph3 at which the first central rail fixing member 51a fixes the central rail 40. Here, for example, the height position Ph1 is the height position of the axial center of the first left rail fixing member 51b, the height position Ph2 is the height position of the axial center of the first right rail fixing member 51c, and the height position Ph3 is the height position of the upper surface of the upper portion 6e of the central plate 6.

The height position Ph1 and the height position Ph2 are the same. In FIG. 7, the difference between the height position Ph3 and each of the height position Ph1 and the height position Ph2 is indicated as Ga. The height position Ph1 and the height position Ph2 may not necessarily be the same and may be substantially the same, and even when the height positions Ph1 and Ph2 are substantially the same, the height positions Ph1 and Ph2 are regarded as the same in the present disclosure. The same applies hereinafter.

As illustrated in FIG. 8, a height position Ph4 at which the second left rail fixing member 52b fixes the left rail 41 and a height position Ph5 at which the second right rail fixing member 52c fixes the right rail 42 are higher than a height position Ph6 at which the second central rail fixing member 52a fixes the central rail 40. Here, for example, the height position Ph4 is the height position of the axial center of the second left rail fixing member 52b, the height position Ph5 is the height position of the axial center of the second right rail fixing member 52c, and the height position Ph6 is the height position of the upper surface of the upper portion 6e of the central plate 6.

The height position Ph4 and the height position Ph5 are the same. In FIG. 8, the difference between the height position Ph6 and each of the height position Ph4 and the height position Ph5 is indicated as Ga.

Further, the height position Ph1 and the height position Ph2 are the same as the height position Ph4 and the height position Ph5. The height position Ph3 and the height position Ph6 are the same.

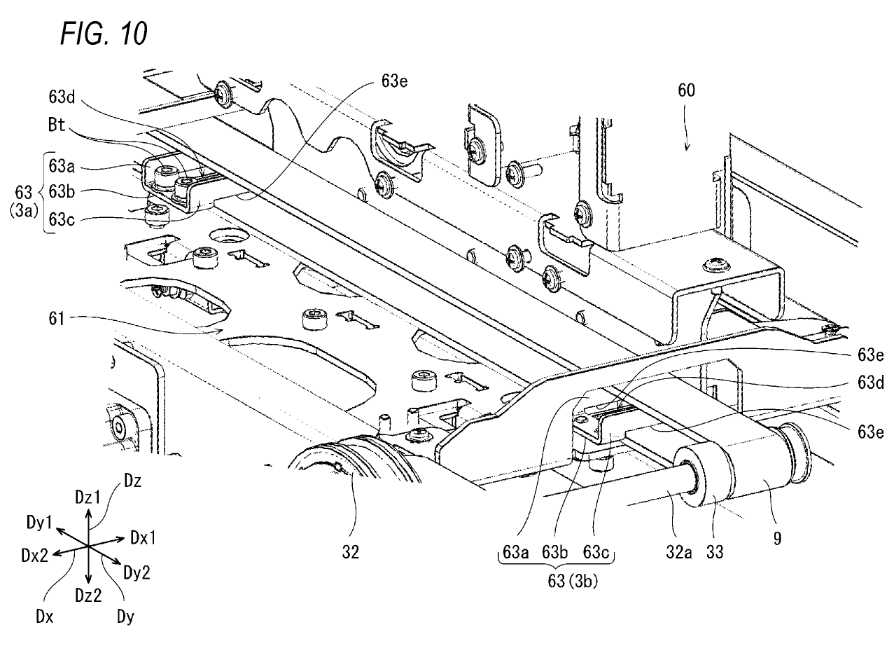

Next, configurations of the central plate 6 and the platen support member 3 will be described in detail with reference to the drawings described above, FIG. 9, and FIG. 10. FIG. 9 is a perspective view illustrating a configuration of a lower portion of the platen support member 3. FIG. 10 is a perspective view illustrating a configuration for fixing the drive belt 9 to the platen support member 3.

As illustrated in FIGS. 7 and 8, the central plate 6 includes side portions 6a and 6d, middle side wall portions 6b and 6c, and the upper portion 6e.

The upper portion 6e extends in the conveying direction Dy and the left-right direction Dx. The upper portion 6e supports the central rail 40 from below. The side portion 6a is coupled to a left end of the upper portion 6e and protrudes downward. The side portion 6d is coupled to a right end of the upper portion 6e and protrudes downward. The middle side wall portion 6b is provided between the side portion 6a and the side portion 6d in the left-right direction Dx and protrudes downward. The middle side wall portion 6c is provided between the side portion 6a and the side portion 6d in the left-right direction Dx and on the right side of the middle side wall portion 6b and protrudes downward.

The bottom frame 10c of the guide frame 10 illustrated in FIG. 7 is provided with four wall portions 10f protruding upward. The side portions 6a and 6d and the middle side wall portions 6b and 6c are fixed to the corresponding wall portions 10f by, for example, screws Bs.

The first left roller pair 70 of the platen support member 3 sandwiches the upper member 41t of the left rail 41 in the up-down direction Dz, and the second left roller pair 71 sandwiches the upper member 41t in the up-down direction Dz. The first right roller pair 80 of the platen support member 3 sandwiches the upper member 42t of the right rail 42 in the up-down direction Dz, and the second right roller pair 81 sandwiches the upper member 42t in the up-down direction Dz.

The manner in which the first left roller pair 70 sandwiches the upper member 41t of the left rail 41 in the up-down direction Dz will be described in detail below. As illustrated in FIGS. 7 and 8, an upper roller R1 and a lower roller R2 of the first left roller pair 70 sandwich the upper member 41t in the up-down direction Dz. Similarly to the first left roller pair 70, the second left roller pair 71 sandwiches the upper member 41t in the up-down direction Dz by an upper roller R1 and a lower roller R2. The second left roller pair 71 is provided at a position away from the first left roller pair 70 in the conveying direction Dy and behind the first left roller pair 70.

The manner in which the first right roller pair 80 sandwiches the upper member 42t of the right rail 42 in the up-down direction Dz will be described in detail below. As illustrated in FIGS. 7 and 8, an upper roller R1 and a lower roller R2 of the first right roller pair 80 sandwich the upper member 42t in the up-down direction Dz. Similarly to the first right roller pair 80, the second right roller pair 81 sandwiches the upper member 42t in the up-down direction Dz by an upper roller R1 and a lower roller R2. The second right roller pair 81 is provided at a position away from the first right roller pair 80 in the conveying direction Dy and behind the first right roller pair 80.

The position of the first left roller pair 70 in the conveying direction Dy is the same as the position of the first right roller pair 80 in the conveying direction Dy. The position of the second left roller pair 71 in the conveying direction Dy is the same as the position of the second right roller pair 81 in the conveying direction Dy.

Here, as illustrated in FIGS. 7 to 9, the upper roller R1 of the first left roller pair 70 is connected to a left end of a shaft Sh1 extending in the left-right direction Dx so as to be rotatable around the shaft Sh1, and the upper roller R1 of the first right roller pair 80 is connected to a right end of the shaft Sh1 so as to be rotatable around the shaft Sh1. The shaft Sh1 is fixed to the base plate 61 of the platen support member 3 by bolts Bt, for example. The shaft Sh1 is inserted into a hole portion HL described later in the roller attachment member 62 provided corresponding to the lower roller R2 of the first right roller pair 80 and a hole portion (not illustrated) similar to the hole portion HL in the roller attachment member 62 provided corresponding to the lower roller R2 of the first left roller pair 70.

The upper roller R1 of the second left roller pair 71 is connected to a left end of a shaft Sh1 extending in the left-right direction Dx so as to be rotatable around the shaft Sh1, and the upper roller R1 of the second right roller pair 81 is connected to a right end of the shaft Sh1 so as to be rotatable around the shaft Sh1. The shaft Sh1 is fixed to the base plate 61 of the platen support member 3 by bolts Bt, for example. The shaft Sh1 is inserted into the hole portion HL described later in the roller attachment member 62 provided corresponding to the lower roller R2 of the second left roller pair 71 and the hole portion HL described later in the roller attachment member 62 provided corresponding to the lower roller R2 of the second right roller pair 81.

The roller attachment member 62 is formed in, for example, an L shape. The roller attachment member 62 is provided corresponding to the lower roller R2 of the first left roller pair 70, the lower roller R2 of the first right roller pair 80, the lower roller R2 of the second left roller pair 71, and the lower roller R2 of the second right roller pair 81, and the lower roller R2 is rotatably attached thereto. As illustrated in FIG. 9, the roller attachment member 62 is fixed to the base plate 61 by, for example, screws Bs.

The roller attachment member 62 includes an upper portion 62a and a side portion 62b. The upper portion 62a extends in the left-right direction Dx. The upper portion 62a is fixed to the base plate 61 by, for example, screws Bs.

The side portion 62b is coupled to one end of the upper portion 62a in the left-right direction Dx and extends downward. As illustrated in FIG. 9, the side portion 62b is provided with the hole portion HL through which the shaft Sh1 connected to the upper roller R1 and the shaft Sh2 connected to the lower roller R2 are inserted. The lower roller R2 of each of the first left roller pair 70, the first right roller pair 80, the second left roller pair 71, and the second right roller pair 81, which are the four roller pairs, is connected to the shaft Sh2 inserted into the hole portion HL and extending in the left-right direction Dx so as to be rotatable around the shaft Sh2. The shaft Sh2 is fixed by nuts Nu provided on the left side and the right side of the side portion 62b. With the above configuration, the base plate 61 is coupled to the first left roller pair 70, the first right roller pair 80, the second left roller pair 71, and the second right roller pair 81.

As illustrated in FIGS. 7 and 8, a pair of rollers R3 and R4 are provided below the shaft Sh1 connected to the upper roller R1 of the first left roller pair 70 and the upper roller R1 of the first right roller pair 80. The roller R3 is connected to a shaft Sh fixed to the base plate 61 and extending in the up-down direction Dz so as to be rotatable around the shaft Sh. The roller R3 is provided on the left side of the central rail 40 and is in contact with the central rail 40. The roller R4 is connected to a shaft Sh fixed to the base plate 61 and extending in the up-down direction Dz so as to be rotatable about the shaft Sh. The roller R4 is provided on the right side of the central rail 40 and is in contact with the central rail 40.

A pair of rollers R5 and R6 are provided below the shaft Sh1 connected to the upper roller R1 of the second left roller pair 71 and the upper roller R1 of the second right roller pair 81. The pair of rollers R5 and R6 are provided behind the pair of rollers R3 and R4 in the conveying direction Dy. The roller R5 is connected to a shaft Sh fixed to the base plate 61 and extending in the up-down direction Dz so as to be rotatable around the shaft Sh. The roller R5 is provided on the left side of the central rail 40 and is in contact with the central rail 40. The roller R6 is connected to a shaft Sh fixed to the base plate 61 and extending in the up-down direction Dz so as to be rotatable about the shaft Sh. The roller R6 is provided on the right side of the central rail 40 and is in contact with the central rail 40. In the above configuration, when the platen support member 3 moves in the conveying direction Dy, the first left roller pair 70 and the second left roller pair 71 slide on the upper member 41t of the left rail 41 along the conveying direction Dy, and the first right roller pair 80 and the second right roller pair 81 slide on the upper member 42t of the right rail 42 along the conveying direction Dy. At this time, the pair of rollers R3 and R4 and the pair of rollers R5 and R6 rotate around the shaft Sh while being in contact with the central rail 40. As described above, the position of the platen support member 3 in the left-right direction Dx is regulated by the central rail 40, and the platen 1 is conveyed in the conveying direction Dy.

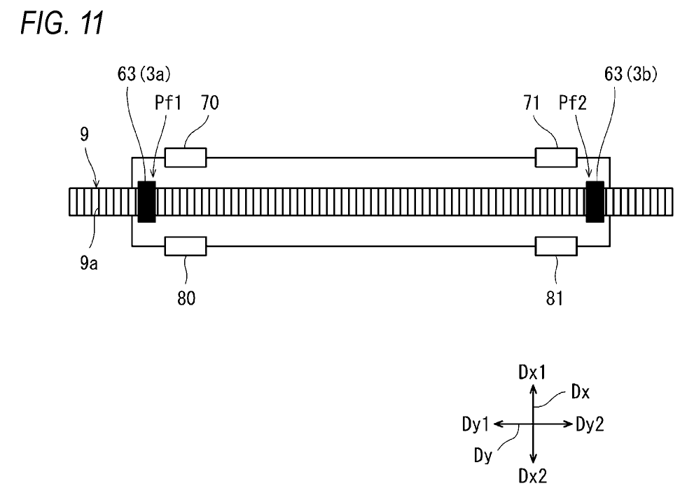

Next, FIG. 10 is a perspective view illustrating a configuration for fixing the drive belt 9 to the platen support member 3. FIG. 11 is a schematic plan view illustrating a fixing position of the drive belt 9 with respect to the platen support member 3.

As illustrated in FIG. 10, the platen support member 3 has one end portion 3a positioned at the front, which is an example of one side in the conveying direction Dy, and the other end portion 3b positioned at the rear, which is an example of the other side in the conveying direction Dy. The drive belt 9 is fixed at one end portion 3a and the other end portion 3b of the platen support member 3. Specifically, the platen support member 3 has two fixing members 63 as the one end portion 3a and the other end portion 3b.

Each fixing member 63 includes a front portion 63a, a coupling portion 63b, and a rear portion 63c. The front portion 63a extends in the up-down direction Dz. The dimension in the left-right direction Dx, which is the width of the front portion 63a, is larger than the dimension in the left-right direction Dx, which is the width of the drive belt 9. The rear portion 63c extends in the up-down direction Dz. The dimension in the left-right direction Dx, which is the width of the rear portion 63c, is larger than the dimension in the left-right direction Dx, which is the width of the drive belt 9. The coupling portion 63b extends in the conveying direction Dy. The coupling portion 63b is coupled to a lower end of the front portion 63a and a lower end of the rear portion 63c.

The front portion 63a and the rear portion 63c are each provided with a slit 63e extending in the left-right direction Dx. The coupling portion 63b is provided with an uneven portion 63d. The drive belt 9 is inserted into the two slits 63e of the fixing member 63 as the one end portion 3a and is inserted into the two slits 63e of the fixing member 63 as the other end portion 3b.

Here, one surface of the drive belt 9 is provided with ribs 9a illustrated in FIG. 11 described later. The rib 9a of the drive belt 9 is engaged with the uneven portion 63d of the fixing member 63 as the one end portion 3a and is engaged with the uneven portion 63d of the fixing member 63 as the other end portion 3b. In this state, the coupling portion 63b is fixed to the base plate 61 by, for example, a plurality of bolts Bt. Accordingly, the base plate 61 is fixed to the drive belt 9 by the fixing member 63.

As illustrated in FIG. 11, in the present embodiment, a first fixing position Pf1 between the drive belt 9 and the one end portion 3a of the platen support member 3 is positioned forward, which is an example of one side in the conveying direction Dy, relative to the first left roller pair 70 and the first right roller pair 80. A second fixing position Pf2 between the drive belt 9 and the other end portion 3b of the platen support member 3 is positioned rearward, which is an example of the other side in the conveying direction Dy, relative to the second left roller pair 71 and the second right roller pair 81.

As described above, according to the present embodiment, the first rail fixing member 51 and the second rail fixing member 52 fix the rail 4 at a position closer to the printing position Pp than the one end 4a and the other end 4b of the rail 4 in the conveying direction Dy. Therefore, compared with a case in which the one end 4a and the other end 4b of the rail 4 in the conveying direction Dy are fixed, the rail 4 is less likely to bend due to the weight of the platen 1, an external force, or the like. Therefore, the amount of deviation of the platen 1 from the desired position is reduced. Accordingly, it is possible to prevent a decrease in landing accuracy due to a deviation of landing positions of ink droplets ejected from the ejection head 2. Therefore, deterioration in image quality can be prevented.

In the present embodiment, the first rail fixing member 51 and the second rail fixing member 52 fix the rail 4 at a position closer to the printing position Pp than the one end 4a and the other end 4b of the rail 4 in the conveying direction Dy and across the printing position Pp. Therefore, the rail 4 is less likely to bend in the vicinity of the printing position Pp due to the weight of the platen 1, an external force, or the like. Therefore, the amount of deviation of the platen 1 from the desired position in the vicinity of the printing position Pp is further reduced. Accordingly, it is possible to further prevent a decrease in landing accuracy due to a deviation of landing positions of ink droplets ejected from the ejection head 2. Therefore, deterioration in image quality can be further prevented.

In the present embodiment, by providing the third rail fixing member 53, the amount of deviation of the platen 1 from the desired position is further reduced. In addition, the first interval S1 between the third rail fixing member 53 and the first rail fixing member 51 in the conveying direction Dy is larger than the second interval S2 between the first rail fixing member 51 and the second rail fixing member 52 in the conveying direction Dy. Accordingly, it is possible to efficiently reduce the amount of positional deviation of the platen support member 3 at the printing position Pp where it is desired that the positional deviation is relatively small by a small number of rail fixing members.

In the present embodiment, the central rail 40 is positioned and fixed in the left-right direction Dx, and the left rail 41 and the right rail 42 are positioned and fixed in the up-down direction Dz. Therefore, the fixing can be easily performed as compared with a case in which one rail is positioned and fixed in the left-right direction Dx and the up-down direction Dz.

In the present embodiment, the height positions Ph3 and Ph6 for fixing the central rail 40 are lower than the height positions Ph1 and Ph4 for fixing the left rail 41 and the height positions Ph2 and Ph5 for fixing the right rail 42. Therefore, as compared with a case in which the height positions Ph3 and Ph6 are higher than the height positions Ph1 and Ph4 and the height positions Ph2 and Ph5, interference caused by the first central rail fixing member 51a and the second central rail fixing member 52a is less likely to occur when the shaft Sh1 is disposed at the height positions Ph1 and Ph4 and the height positions Ph2 and Ph5 in the left-right direction Dx. In addition, since the upper roller R1 of the first left roller pair 70 and the upper roller R1 of the first right roller pair 80 are connected to the coaxial shaft Sh1, the height position of the upper roller R1 of the first left roller pair 70 and the height position of the upper roller R1 of the first right roller pair 80 are likely to be the same as compared with a case in which the upper rollers R1 and R1 are connected to a non-coaxial shaft. Therefore, the shaft Sh1 to which the upper roller R1 of the first left roller pair 70 and the upper roller R1 of the first right roller pair 80 are connected is likely to be parallel to the left-right direction Dx. Accordingly, the conveyance accuracy is improved as compared with a case in which the shaft Sh1 is inclined with respect to the left-right direction Dx. Since the upper roller R1 of the first left roller pair 70 and the upper roller R1 of the first right roller pair 80 are connected to the shaft Sh1, the positional accuracy of the platen support member 3 is improved as compared with a case in which they are connected to a non-coaxial shaft. As compared with the case in which the height positions Ph3 and Ph6 are higher than the height positions Ph1 and Ph4 and the height positions Ph2 and Ph5 as described above, the diameter of the upper roller R1 can be reduced on the premise that the shaft Sh1 is positioned at a position higher than the height positions Ph3 and Ph6. Further, the side member 41s coupled to the upper member 41t of the left rail 41 sandwiched by the first left roller pair 70 and the second left roller pair 71 is fixed by the first left rail fixing member 51b, the second left rail fixing member 52b, the third left rail fixing member 53b, and the like. That is, the side member 41s is fixed in the vicinity of the upper member 41t having a sliding surface on which the first left roller pair 70 and the second left roller pair 71 slide. The side member 42s coupled to the upper member 42t of the right rail 42 sandwiched by the first right roller pair 80 and the second right roller pair 81 is fixed by the first right rail fixing member 51c, the second right rail fixing member 52c, the third right rail fixing member 53c, and the like. That is, the side member 42s is fixed in the vicinity of the upper member 42t having a sliding surface on which the first right roller pair 80 and the second right roller pair 81 slide. Accordingly, the rigidity and the positional accuracy of the upper members 41t and 42t are improved, and thus the conveyance accuracy of the platen 1 implemented by the platen support member 3 is improved.

In the present embodiment, the height position Ph1 at which the first left rail fixing member 51b fixes the left rail 41 and the height position Ph2 at which the first right rail fixing member 51c fixes the right rail 42 are the same as the height position Ph4 at which the second left rail fixing member 52b fixes the left rail 41 and the height position Ph5 at which the second right rail fixing member 52c fixes the right rail 42. Therefore, the platen support member 3 is less likely to be inclined in the conveying direction Dy than when the height positions Ph1 and Ph2 are different from the height positions Ph4 and Ph5.

In the present embodiment, since the central rail 40 is fixed to the central plate 6 extending in the conveying direction Dy and the left-right direction Dx, the levelness of the central rail 40 is improved as compared with a case in which the central rail 40 is not fixed to the central plate 6.

In the present embodiment, the platen support member 3 includes the left roller pair 7 configured to sandwich the left rail 41 in the up-down direction Dz and the right roller pair 8 configured to sandwich the right rail 42 in the up-down direction Dz. Therefore, it is possible to prevent rattling of the platen support member 3 with respect to the left rail 41 and the right rail 42 while reducing the conveying resistance as compared with a case in which the platen support member 3 moves in the conveying direction Dy via, for example, a ball bush.

In the present embodiment, the roller R3 and the roller R4 are provided with the central rail 40 interposed therebetween in the left-right direction Dx, and the roller R5 and the roller R6 are provided behind the roller R3 and the roller R4 in the conveying direction Dy with the central rail 40 interposed therebetween in the left-right direction Dx. Accordingly, the platen support member 3 can be conveyed in the conveying direction Dy along the central rail 40 in a state of being regulated in the left-right direction Dx.

When the drive belt 9 is fixed to the platen support member 3 at the center of the platen support member 3, the platen support member 3 is likely to be inclined with respect to the conveying direction Dy when the printed medium W is conveyed. With respect to this, according to the present embodiment, since the drive belt 9 is fixed by the fixing member 63 as the one end portion 3a and the fixing member 63 as the other end portion 3b of the platen support member 3, the platen support member 3 is less likely to be inclined with respect to the conveying direction Dy during conveying.

In the present embodiment, the first fixing position Pf1 between the drive belt 9 and the one end portion 3a of the platen support member 3 is positioned forward, which is an example of the one side in the conveying direction Dy, relative to the first left roller pair 70 and the first right roller pair 80. The second fixing position Pf2 between the drive belt 9 and the other end portion 3b of the platen support member 3 is positioned rearward, which is an example of the other side in the conveying direction Dy, relative to the second left roller pair 71 and the second right roller pair 81. Therefore, the platen support member 3 is less likely to be inclined with respect to the conveying direction Dy during conveying than in a case in which the first fixing position Pf1 is positioned rearward relative to the first left roller pair 70 and the first right roller pair 80 in the conveying direction Dy and the second fixing position Pf2 is positioned forward relative to the second left roller pair 71 and the second right roller pair 81 in the conveying direction Dy.

The present disclosure is not limited to the embodiment described above, and following modifications can be adopted without departing from the gist of the present disclosure.

In the embodiment described above, the first rail fixing member 51 is provided closer to the front end than the platen support member 3 in the conveying direction Dy in a state in which the platen support member 3 is disposed at the printing position Pp, and the second rail fixing member 52 is provided closer to the trailing end than the platen support member 3 in the conveying direction Dy in a state in which the platen support member 3 is disposed at the printing position Pp, but the prevent invention is not limited thereto. The first rail fixing member 51 may be provided closer to the trailing end than the platen support member 3 in the conveying direction Dy in a state in which the platen support member 3 is disposed at the printing position Pp, and the second rail fixing member 52 may be provided closer to the front end than the platen support member 3 in the conveying direction Dy in a state in which the platen support member 3 is disposed at the printing position Pp.

In the above embodiment, the first interval S1 between the third rail fixing member 53 and the first rail fixing member 51 in the conveying direction Dy is larger than the second interval S2 between the first rail fixing member 51 and the second rail fixing member 52 in the conveying direction Dy, but the present invention is not limited thereto. The first interval S1 may be the same as the second interval S2 or may be smaller than the second interval S2.

In the above embodiment, the rail 4 includes the central rail 40, the left rail 41, and the right rail 42, but the present invention is not limited thereto. The number of rails 4 may be one or four or more.

In the above embodiment, the height positions Ph3 and Ph6 are lower than the height positions Ph1 and Ph4 and the height positions Ph2 and Ph5, but the present invention is not limited thereto. The height positions Ph3 and Ph6 may be higher than the height positions Ph1 and Ph4 and the height positions Ph2 and Ph5.

In the above embodiment, the height positions Ph1 and Ph2 are the same as the height positions Ph4 and Ph5, but the present invention is not limited thereto. The height positions Ph1 and Ph2 may be different from the height positions Ph4 and Ph5.

Further, in the above embodiment, the first fixing position Pf1 is positioned forward relative to the first left roller pair 70 and the first right roller pair 80 in the conveying direction Dy, and the second fixing position Pf2 is positioned rearward relative to the second left roller pair 71 and the second right roller pair 81 in the conveying direction Dy, but the present invention is not limited thereto. The first fixing position Pf1 may be positioned rearward relative to the first left roller pair 70 and the first right roller pair 80 in the conveying direction Dy, and the second fixing position Pf2 may be positioned forward relative to the second left roller pair 71 and the second right roller pair 81 in the conveying direction Dy.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing apparatus comprising:
a rail extending in a conveying direction of a printed medium;
a platen support member mounted on the rail, the platen support member configured to: support a platen on which the printed medium is placed; and move the platen along the rail between a printing position where liquid droplets are ejected from an ejection head to the printed medium and a set position where the printed medium is set on the platen;
a first rail fixing member provided between one end and the other end of the rail in the conveying direction, the first rail fixing member configured to fix the rail; and
a second rail fixing member provided at a position between the one end and the other end of the rail in the conveying direction and away from the first rail fixing member, the second rail fixing member configured to fix the rail.

2. The printing apparatus according to claim 1,
wherein in a state in which the platen support member is disposed at the printing position, in the conveying direction, the first rail fixing member is provided closer to the one end side than the platen support member, and the second rail fixing member is provided closer to the other end side than the platen support member.

3. The printing apparatus according to claim 2, further comprising:
a third rail fixing member provided at a position between the one end and the other end of the rail in the conveying direction and away from the first rail fixing member and the second rail fixing member, the third rail fixing member configured to fix the rail,
wherein the first rail fixing member is provided between the third rail fixing member and the second rail fixing member in the conveying direction, and
wherein a first interval between the third rail fixing member and the first rail fixing member in the conveying direction is larger than a second interval between the first rail fixing member and the second rail fixing member in the conveying direction.

4. The printing apparatus according to claim 1,
wherein the rail includes a central rail, a left rail, and a right rail,
wherein the left rail is provided on a left side of the central rail in a left-right direction intersecting the conveying direction,
wherein the right rail is provided on a right side of the central rail in the left-right direction,
wherein the first rail fixing member includes:
a first central rail fixing member configured to fix the central rail in the left-right direction;
a first left rail fixing member configured to fix the left rail in an up-down direction intersecting both the conveying direction and the left-right direction; and
a first right rail fixing member configured to fix the right rail in the up-down direction, and
wherein the second rail fixing member includes:
a second central rail fixing member configured to fix the central rail in the left-right direction,
a second left rail fixing member configured to fix the left rail in the up-down direction, and
a second right rail fixing member configured to fix the right rail in the up-down direction.

5. The printing apparatus according to claim 4,
wherein a first-left height position at which the first left rail fixing member fixes the left rail and a first-right height position at which the first right rail fixing member fixes the right rail are higher than a first-central height position at which the first central rail fixing member fixes the central rail, and
wherein a second-left height position at which the second left rail fixing member fixes the left rail and a second-right height position at which the second right rail fixing member fixes the right rail are higher than a second-central height position at which the second central rail fixing member fixes the central rail.

6. The printing apparatus according to claim 4,
wherein a first-left height position at which the first left rail fixing member fixes the left rail and a first-right height position at which the first right rail fixing member fixes the right rail are the same as a second-left height position at which the second left rail fixing member fixes the left rail and a second-right height position at which the second right rail fixing member fixes the right rail.

7. The printing apparatus according to claim 4, further comprising:
a central plate extending in the conveying direction and the left-right direction and provided below the central rail,
wherein the first central rail fixing member and the second central rail fixing member are configured to fix the central rail to the central plate.

8. The printing apparatus according to claim 4,
wherein the platen support member includes: a left roller pair configured to sandwich the left rail in the up-down direction; and a right roller pair configured to sandwich the right rail in the up-down direction.

9. The printing apparatus according to claim 1, further comprising:
a drive belt extending in the conveying direction, the drive belt configured to move the platen support member in the conveying direction,
wherein the platen support member includes: one end portion positioned on one side in the conveying direction; and the other end portion positioned on the other side in the conveying direction, and
wherein the drive belt is fixed at the one end portion and the other end portion of the platen support member.

10. The printing apparatus according to claim 9,
wherein the platen support member includes: a first left roller pair configured to sandwich the left rail in the up-down direction; a first right roller pair configured to sandwich the right rail in the up-down direction; a second left roller pair provided at a position away from the first left roller pair in the conveying direction and configured to sandwich the left rail in the up-down direction; and a second right roller pair provided at a position away from the first right roller pair in the conveying direction and configured to sandwich the right rail in the up-down direction,
wherein the first left roller pair and the first right roller pair are provided closer to the one side in the conveying direction than the second left roller pair and the second right roller pair,
wherein a first fixing position between the drive belt and the one end portion of the platen support member is positioned closer to the one side in the conveying direction than the first left roller pair and the first right roller pair, and
wherein a second fixing position between the drive belt and the other end portion of the platen support member is positioned closer to the other side in the conveying direction than the second left roller pair and the second right roller pair.
